(19) United States
(12) Patent Application Publication
(10) Pub. No.: US 2003/0147347 A1
(43) Pub. Date: Aug. 7, 2003

(54) Method for congestion control and associated switch controller

(76) Inventors: Jen-Kai Chen, Taipei (TW); Hsiao-Lung Wu, Taipei (TW)

Correspondence Address: Raymond Sun, 12420 Woodhall Way, Tustin, CA, 92782, US

(21) Appl. No.: 10/350,602

(22) Filed: Jan. 24, 2003

(30) Foreign Application Priority Data
Feb. 5, 2002 (TW) 91101938

(51) Int. Cl. H04L 1/00

(52) U.S. Cl. 370/229; 370/413

(57) ABSTRACT

The present invention provides a method for congestion control and an associated switch controller. The switch controller performs either a shared memory architecture or an equal memory partition structure which limits the length of a queue corresponding to each port in response to buffer space. When exceeding a predetermined length, the queue will enter into a congested state. Preferrably, if a source port requests to establish a link in the queue, flow control is performed, and the length of the queue will be limited since there are no more packets to be received in. After escaping congestion, the switch controller returns to the shared memory architecture. Thus, the unfairness problem is improved when the network congests while network performance is enhanced.

### BACKGROUND OF THE INVENTION

(a). Field of the Invention

The present invention relates in general to a switch controller and associated method for congestion control, and more particularly to a control method which prevents a single port from occupying too much system resource.

(b). Description of the Prior Arts

Under the e-trend, Local Area Network (LAN) is widely developed in recent years. Though there are many kinds of LAN technologies, such as Ethernet, Token Ring and Fiber Distributed Data Interface (FDDI), the most commonly used is Ethernet. Furthermore, fast Ethernet upgrades the transmission rate from 10 Mbps to 100 Mbps (even 1 Gbps now).

In Ethernet networks, a hub or a switch connects PCs, workstations, servers and so on. Though an Ethernet hub costs less, its bandwidth is shared by all devices connected thereto. Thus the more the connected devices, the more frequently collisions of packets happen. This will impact the performance of network seriously when traffic is heavy.

To solve the problem mentioned, an Ethernet switch is developed. The Ethernet switch learns addresses of connected devices in a forwarding table. When the switch receives a frame, it will check whether the destination address of the frame is in the forwarding table. If so, it will forward the frame to a corresponding port; if not, it will broadcast the frame to all ports. Based on source MAC (SMAC) address and source port of a packet, the switch updates the forwarding table, and establishes a new correspondence between the destination address and the port. The Ethernet switch can better utilize its bandwidth by the above mechanism and improve the efficiency of network operation.

The controller in an Ethernet switch can perform congestion control to improve network throughput. When a destination port congests and packets continue forwarding to the congested port, the controller should perform congestion control for the source port of the packet according to the capability of the device connected to it, and thereby prevent other packets from being sent to the congested destination port again.

IEEE supplements 802.3u standard with auto negotiation which allows an Ethernet switch controller and a device (an network interface card, for example) connected thereto obtaining the capability of each other. The Ethernet switch controller starts the auto negotiation with the connected device in order to negotiate a proper mode of congestion control according to the capability of the connected device. Generally speaking, there are three kinds of congestion control: (1) when the connected device is full-duplex and capable of flow control, flow control is performed; (2) when the connected device is full-duplex and incapable of flow control, drop control is performed; (3) when the connected device is half-duplex and incapable of flow control, backpressure is performed. However, once the congested destination port is released from congestion, congestion control is stopped, and the controlled source ports start to receive packets normally.

But the above implementation needs the switch controller to properly manage a buffer which stores packets in order to get the best performance of congestion control. Let's review first what problems the way a conventional Ethernet switch controller manages the buffer will cause. An Ethernet switch builds in a memory used as a buffer for storing packets temporarily. After a port receives a packet from network, the controller looks up the destination port of the packet in the forwarding table, sends the packet into the buffer, and then establishes a link in an output queue corresponding to the destination port. Then, when outputting the packet, the switch controller will send the packet out of the buffer based on the link established previously in the output queue. Conventionally, each port can use the buffer unlimitedly. While the traffic in each port is different, to limit the buffer space each port can use in advance may cause a problem as follows: a port with heavy traffic will exhaust its quota, though a port with light traffic will leave its space vacant. Thus, system resource can't be fully utilized and the performance of network will then lower down.

However, the Ethernet switch controller adopting this “shared memory architecture” encounters a serious problem when the network falls into congestion. If a lot of packets come into a low-speed port to send out in a short time, then this port will become congested, and most space of the buffer will be occupied by these packets. Therefore, there is little space left for other ports. If a high-speed port suffers slightly heavy traffic load, the buffer will soon use up, then the high-speed port must stop receiving packets until the low-speed port outputs its packets to free the buffer space. In other words, the transmission rate of the high-speed port will be significantly restricted by the transmission rate of the low-speed port.

In brief, the shared memory architecture which a conventional Ethernet switch controller uses will result in a fairness issue because a high-speed port will be encumbered by a low-speed port when the latter gets congested.

### SUMMARY OF THE INVENTION

The present invention provides a method for congestion control and an associated switch controller. When network congests, the switch controller will change its shared memory architecture into an equal memory partition structure which limits the length of an output queue corresponding to each port. When exceeding a predetermined length, the output queue will enter into a congested state. If a source port requests to establish a link, it starts flow control, and the length of the output queue is thus limited since there are no more packets to be received in. In other words, each output queue can only use a same size of buffer space, so the equal memory partition structure is performed. As the length of the output queue is controlled, the problem that a low-speed port slows down the rate of other ports by exhausting buffer resource is improved.

Further, the present invention optimizes fairness policy to allow the equal memory partition structure without packet loss. Optimal fairness means that the period for a congested destination port staying in congestion is in inverse proportion to its output rate so the period for a port to transmit a packet is in inverse proportion to the transmission rate of the port.

After the network escapes congestion, the switch controller returns to the shared memory architecture. Thus, the unfairness issue is solved and network performance is improved.

The present invention defines three states of the system: XON (normal), XOFF (congested) and ALL XOFF (seriously congested). Congestion control is performed based on these states. When free space of the buffer is less than a predetermined “threshold of system congestion”, the system enters into the XOFF state and buffer management is changed from the shared memory architecture to the equal memory partition structure, as described above.

Further, if system congestion gets worse such that free space of the buffer is less than a predetermined “threshold of serious system congestion”, then the system enters into the ALL XOFF state. At this time, the system is in a seriously congested condition and extremely short of resources, so the switch controller must perform flow control for all ports to prevent packet loss. When free space of the buffer gets back to a predetermined “threshold of escaping serious system congestion”, the system returns to the XOFF state; the system does not fully escape congestion until free space of the buffer increases to a predetermined “threshold of escaping system congestion”, while the buffer management is changed from the equal memory partition structure back to the shared memory architecture.

### BRIEF DESCRIPTION OF THE DRAWINGS

FIG. 1 shows a block diagram of an Ethernet switch according to the present invention.

FIG. 2 shows a block diagram of a preferred embodiment of the Ethernet switch controller of FIG. 1.

FIG. 3 is the diagram which illustrates the buffer space in the Ethernet switch of FIG. 1 with respect to time.

FIG. 4 is the diagram which illustrates the length of a output queue with respect to time.

FIG. 5 is the diagram which illustrates how a source port performs flow control by using the RX_ON/RX_OFF window.

### DETAILED DESCRIPTION OF THE PRESENT INVENTION

The detailed description with a preferred embodiment and appended drawings is provided to better understand the goals and features of the present invention.

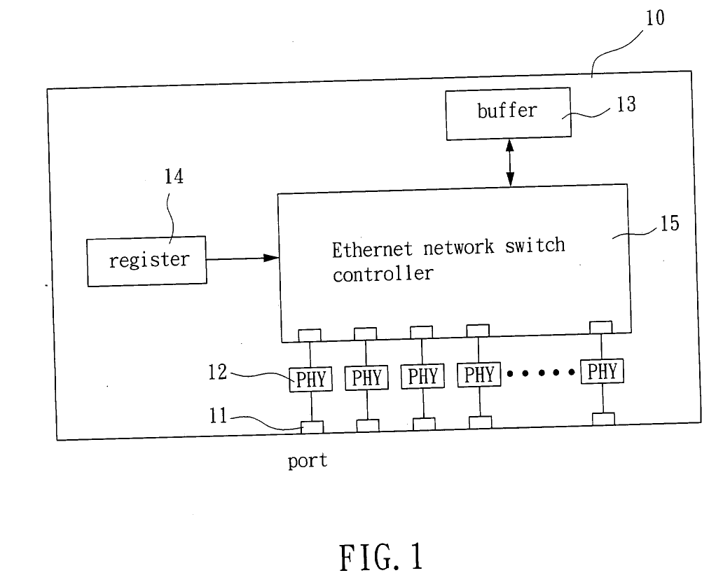

Please refer to FIG. 1, which is a block diagram of an Ethernet switch according to the present invention. As shown in FIG. 1, an Ethernet switch 10 comprises: a plurality of ports 11 for receiving or sending packets; a plurality of PHY devices 12, coupled to the ports 11 respectively; a buffer 13 for temporarily storing packets to be sent out; a register 14 for storing related setting values of congestion control; and an Ethernet switch controller 15, coupled to the PHY devices 12, for performing packet switching and congestion control based on the setting values of the register 14 when congestion occurs.

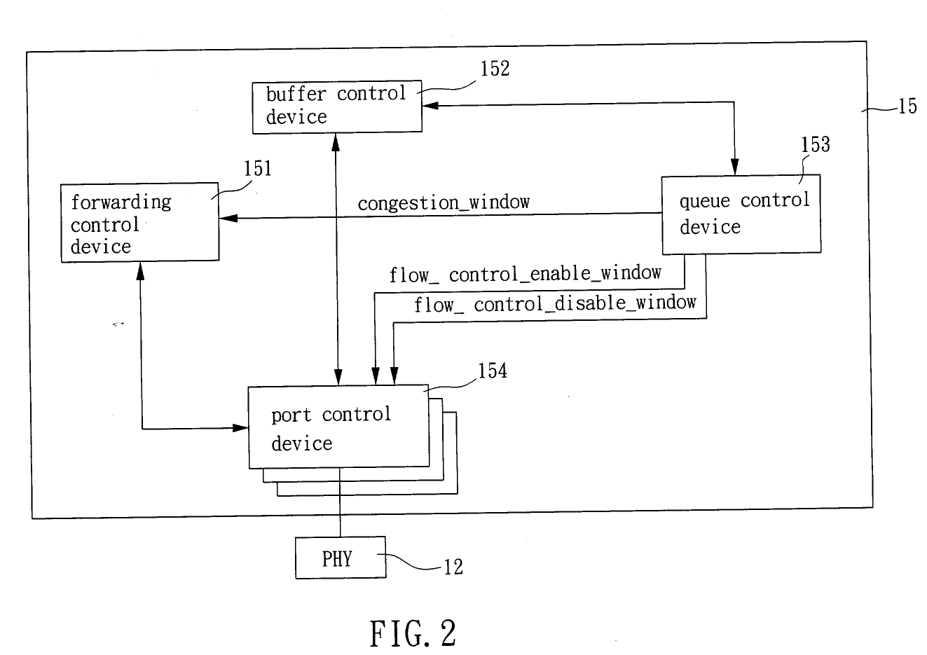

Please refer to FIG. 2, which is a block diagram of a preferred embodiment of the Ethernet switch controller 15 of FIG. 1. As shown in FIG. 2, the Ethernet switch controller 15 comprises: a plurality of port control devices 154, a queue control device 153, a forwarding control device 151, and a buffer control device 152. The plurality of port control devices 154, coupled to the plurality of PHY devices 12 which can obtain status signals of their connected devices by auto-negotiation mechanism. According to these signals, such as duplex mode signals and flow control capability signal, whether the connected devices are full/half duplex and have flow control capability or not is determined in order to select a proper mode of congestion control.

The forwarding control device 151, coupled to the plurality of port control devices 154, looks up the forwarding table according to the headers of packets received by the plurality of port control devices 154, and thereby determines the destination ports which the packets will be forwarded to. The buffer control device 152, coupled to the plurality of port control devices 154 which can issue requests to the buffer 13 for space, allocates or frees buffer space based on the requests of these port control devices 154.

The queue control device 153 is coupled to the plurality of port control devices 154, the buffer control device 152, and the forwarding control device 151. Each port control device 154 has its corresponding output queue in the queue control device 153. The queue control device 153 establishes links in corresponding queues based on the requests sent from the plurality of port control devices 154. If an output queue in the queue control device 153 has entered into congestion, a congestion_window signal will be sent to the forwarding control device 151, and also a flow control_enable_window signal will be asserted to request to perform congestion control for the source port.

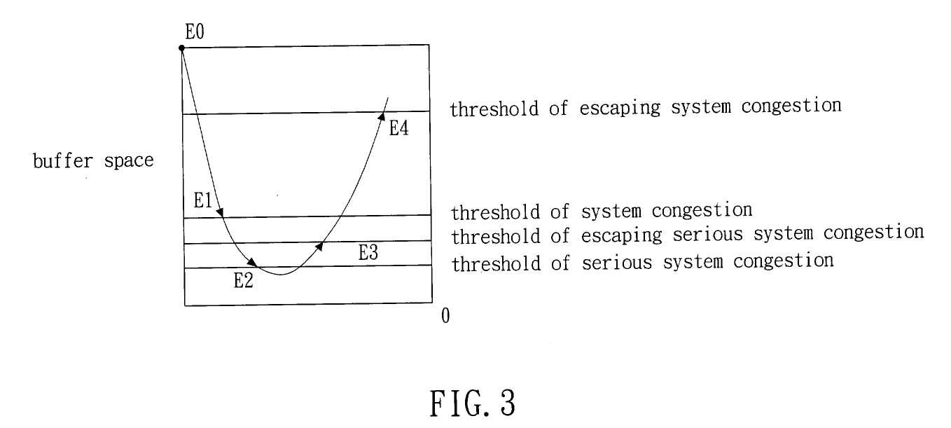

Further, it will be described in detail how to utilize the hardware architecture mentioned above to implement the congestion control of the present invention. Please refer to FIG. 3, which illustrates buffer space in the Ethernet switch 10 of FIG. 1 with respect to time. At the time of system initialization, the buffer 13 within the Ethernet switch 10 doesn't store any packets, shown as E0 in FIG. 3. After initialization, the switch 10 starts to receive packets from ports 11 and stores them in the buffer 13 temporarily.

When remaining space of the buffer 13 is still larger than or equal to the threshold of system congestion, the system is in the XON state without congestion. There's no port 11 entering into a flow-controlled state. Therefore, any received packet can be forwarded out normally. This receiving-forwarding process can be described as follows: A port control device 154 receives a packet from a corresponding port 11 by way of a corresponding PHY device 12. The forwarding control device 151 looks up the routing table to determine the destination port. The port control device 154 then requests space of the buffer 13 for storing the packet and the buffer control device 152 allocates the space based on the request. Next, the port control device 154 commands the queue control device 153 to establish a link in an output queue corresponding to the destination port. Finally, the port control device 154 of the destination port sends out the packet from the output queue, and the buffer control device 152 frees the space occupied by the packet.

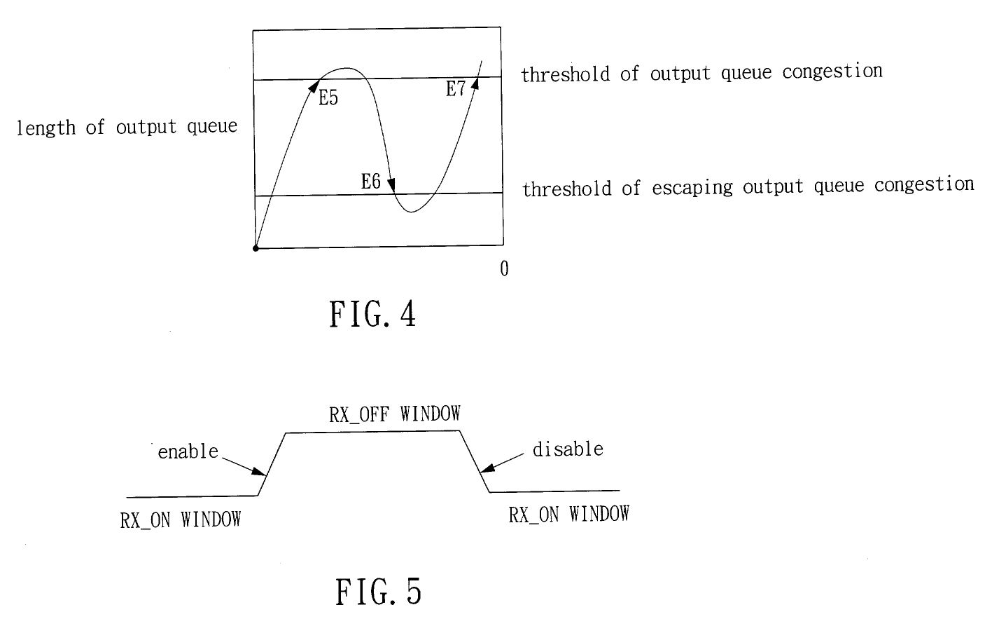

However, when the remaining space of the buffer 13 decreases to lower than the threshold of system congestion, shown as E1 in FIG. 3, the system changes from the XON state to the XOFF state, which represents the congested state. As there's no much buffer space left, the shared memory architecture is not suitable at this time. Rather, the equal memory partition structure is adopted here to limit each output queue to use a same limited size of buffer space. Thus, the output queue of a low-speed port will not occupy too much space and slow down the transmission rate of the whole network. Please refer to FIG. 4. If the length of an output queue increases to be larger than or equal to a given “the threshold of output queue congestion” (E5), the output queue then enters into a local congested state and starts congestion control. The queue control device 153 asserts a congestion_window signal for the output queue to the forwarding control device 151. After that, if a source port receives a packet and requests to establish a link in the output queue, then the queue control device 153 asserts a flow_control_enable_window signal to the port control device 154 of the source port, so as to activate congestion control for the source port. The source port will not receive any incoming packets and the length of the output queue will be subject to control. For example, it can stop the device connected to the source port from sending any packet for a period of time (e.g. time period FF) by sending a pause frame with delay time FF to the device.

When the congested output queue continues to output packets from the buffer 13 such that the length decreases to be shorter than a given “threshold of escaping output queue congestion”, shown as E6 in FIG. 4 (the “threshold of removing output queue congestion” is smaller than “threshold of output queue congestion”), the output queue then escapes from the local congested state. The queue control device 153 deasserts the congestion_window signal to the forwarding control device 151, and asserts a flow_control_disable_window signal to the port control device 154, which started flow control previously, such that the corresponding source port stops flow control and begins to receive packets again. Nevertheless, if the system is still in the XOFF state, that is, the buffer space hasn't returned to the threshold of escaping system congestion, then the length of each output queue is still limited. When the length reaches the threshold of output queue congestion again, shown as E7 in FIG. 4, the output queue still enters into congestion.

The present invention further provides a scheme to deal with the ALL XOFF state of the system. As shown in FIG. 3, by providing a predetermined threshold of serious system congestion lower than the threshold of system congestion, it can be determined if the system seriously congests. When the remaining space of the buffer 13 is lower than the threshold of serious system congestion, shown as E2 in FIG. 3, which represents that the system is extremely short of resource, all ports 11 should stop receiving any incoming packets to prevent packet loss. When the remaining space of the buffer 13 decreases to be lower than the threshold of serious system congestion, all output queues enter into serious congestion, and all port control devices 154 receive the flow_control_enable_window signals from the queue control device 153 and start flow control for all ports 11.

Once the system enters into the ALL XOFF state, it cannot come back to the XOFF state until the buffer space increases to a given threshold of escaping serious system congestion (the threshold of escaping serious system congestion is larger than the threshold of serious system congestion mentioned above), shown as E3 in FIG. 3. It must be stressed that though the threshold of escaping serious system congestion is smaller than the threshold of system congestion in FIG. 3, there's no definite relation between them. Therefore, it should be noted that it also works to use the threshold of system congestion as the threshold of removing serious system congestion directly. If the increase of the buffer space is due to output of packets from a congested output queue Q (it can be observed from the length of the output queue in FIG. 4), it means that the processing rate of some output queues is very fast and they should not be encumbered by other ports with low processing rate of packets. If length of Q is longer than or equal to the threshold of output queue congestion, Q is still in congestion. On the other hand, if the length of Q is decreased to be lower than the threshold of output queue congestion, Q escapes congestion, and the associated port control device 154 receives the flow control_disable_window signal from the queue control device 153 to stop flow control for said port 11.

No matter the system is in the ALL XOFF or XOFF state, it cannot come back to the XON state until the buffer space increases to a given threshold of escaping system congestion (surely larger than the threshold of system congestion and the threshold of serious system congestion), shown as E4 in FIG. 3, by continuing to forward out the buffered packets. The XON state means the system fully escapes from congestion. All congested output queues should escape congestion, and the queue control device 153 deasserts congestion_window signals corresponding to the congested output queues to the forwarding control device 151 and asserts the flow_control_disable_window signals to the port control devices 154 still in the flow_control state to stop flow control and to receive packets again. Meanwhile, since the buffer space is restored to a normal level, the equal memory partition architecture (i.e. using the threshold of output queue congestion to limit the length of an output queue, shown as E5, E7 in FIG. 4) the switch controller 15 uses in the ALL XOFF or XOFF state is no longer adopted, and the shared memory architecture previously used in the XON state is restored to facilitate all ports 11 to share the buffer 13 unlimitedly. The lengths of the corresponding output queues are fully flexible.

In this preferred embodiment, each output queue can advantageously use at most 4K bytes buffer space in the equal memory partition structure which the switch controller 15 adopts when the system is in the XOFF state. The 4K bytes space is larger than twice the maximum possible length of an Ethernet packet. Therefore, when the system is in the XOFF state, shown as E1 to E2 and E3 to E4 in FIG. 3, if some output queues fall into congestion, other output queues and corresponding ports with normal traffic are still capable of being served.

A more detailed explanation about the flow control in view of a source port is provided here. In the present invention, flow control for a source port is based on the RX_ON/RX_OFF window. Please refer to FIG. 5, which illustrates how a source port performs flow control by using the RX_ON/RX_OFF window. When there's no output queue entering into congestion, all source ports receive incoming packets normally and stay in the RX_ON window. After one output queue enters into congestion, and one source port receives a packet and requests to establish a link in the congested output queue, the port control device 154 of the source port will receive a flow control_enable_window signal which requires flow control. Then the source port will enter into the RX_OFF window, and congestion control is performed: (1) When the connected device is full-duplex and capable of flow control, flow control is performed. According to this mode, the switch controller 15 sends out a flow control frame to the connected device to request it to stop transmitting packets for a predetermined period. (2) When the connected device is full-duplex and incapable of flow control, drop control is performed. In other words, what needs to do is to drop directly the packets transmitted by the connected device. (3) When the connected device is half-duplex and incapable of flow control, backpressure is performed. According to this mode, the switch controller 15 sends out a collision signal to damage a packet, and when the connected device detects the collision, waiting time is calculated by the Binary Exponential Backoff Algorithm. After the waiting time passes, the packet is transmitted again. Therefore, there's no incoming traffic for the source port and congestion control is achieved.

When the output queue escapes congestion, the port control device 154 of the source port will receive the flow_control_disable_window signal from the queue control device 153. Then the source port will change from the RX_OFF window to the RX_ON window to stop flow control and start receiving packets from network again.

All the thresholds mentioned above, including the threshold of system congestion, the threshold of serious system congestion, the threshold of escaping system congestion, the threshold of escaping serious system congestion, the threshold of output queue congestion and the threshold of removing output queue congestion, are stored in the register 14 which can be adjusted by the Ethernet switch controller 15 based on the practical traffic of network.

To sum up, the present invention provides an Ethernet switch controller and associated method of congestion control which can utilize the equal memory partition structure to prevent a single port from using too much system resource when network congestion happens, thereby avoids the issue that the transmission rate of the whole network performance is deteriorated by congested low-speed ports.

While the present invention has been shown and described with reference to a preferred embodiment thereof, and in terms of the illustrative drawings, it should be not considered as limited thereby. Various possible modification and alterations could be conceived of by one skilled in the art to the form and the content of any particular embodiment, without departing from the scope and the sprit of the present invention.

What is claimed is:

1. A method of congestion control, in an Ethernet switch comprising a buffer, a plurality of ports and a plurality of queues corresponding to said plurality of ports, the method comprising:
receiving a packet by one of said ports, storing said packet in said buffer, and establishing a link in a corresponding queue of said queues corresponding to a destination port for said packet;
examining if remaining space of said buffer is smaller than a predetermined threshold of system congestion;
examining if a length of said corresponding queue exceeds a predetermined threshold of queue congestion when the remaining space of said buffer is smaller than said predetermined threshold of system congestion; and
performing a proper congestion control based on the examining results.

2. The method of congestion control of claim 1, wherein said performing step determines whether a request to establish another link in said corresponding queue for a subsequently received packet is granted.

3. The method of congestion control of claim 2, wherein said congestion control comprising:
rejecting said request if the length of said corresponding queue exceeds said threshold of queue congestion;
comparing the length of said corresponding queue with a predetermined threshold of escaping queue congestion which is smaller than said threshold of queue congestion; and
granting said request if the length of said corresponding queue is shorter than said threshold of escaping queue congestion.

4. The method of congestion control of claim 1, further comprising:
examining if said remaining space of said buffer is less than a predetermined threshold of serious system congestion; and
performing said congestion control for subsequently received packets of all said ports if said remaining space of said buffer is less than said threshold of serious system congestion.

5. The method of congestion control of claim 4, further comprising:
outputting at least a packet from said buffer according to a link of the outputted packet in a first one of said queues if said remaining space of said buffer is less than said threshold of serious system congestion;
examining if said remaining space of said buffer is returned to a predetermined threshold of escaping serious system congestion;
examining if a length of said first queue is less than said threshold of queue congestion when said remaining space of said buffer is substantially equal to said threshold of escaping serious system congestion; and
granting a request to establish a link in said first queue for a subsequently received packet if the length of said first queue is less than said threshold of queue congestion.

6. The method of congestion control of claim 5, further comprising:
stopping flow control for said ports when said remaining space of said buffer increases to a predetermined threshold of escaping system congestion.

7. The method of congestion control of claim 5, wherein said threshold of escaping serious system congestion is substantially equal to said threshold of system congestion.

8. The method of congestion control of claim 6, wherein said threshold of system congestion, said threshold of serious system congestion, said threshold of escaping system congestion, said threshold of escaping serious system congestion, said threshold of queue congestion and said threshold of escaping queue congestion are stored in a register of the switch.

9. An Ethernet switch controller comprising:
a buffer control device, coupled to a buffer, for allocating and freeing space of said buffer;
a plurality of port control devices, coupled to said buffer and a plurality of PHY devices, for receiving a plurality of packets from a plurality of ports via said plurality of PHY devices and requesting a space of said buffer to store said plurality of packets;
a forwarding control device, coupled to said plurality of port control devices, for determining a destination port for each of said packets;
a queue control device, coupled to said plurality of port control devices, said buffer control device and said forwarding control device, said queue control device comprising a plurality of queues corresponding to said plurality of ports and establishing a link in a corresponding queue of said queues corresponding to said destination port based on requests issued by said plurality of port control devices; and
wherein said switch controller examines if remaining space of said buffer is less than a predetermined threshold of system congestion, if the remaining space of said buffer is less than said threshold of system congestion, then examine if a length of said corresponding queue exceeds a predetermined threshold of queue congestion and perform a proper congestion control based on said examining results.

10. The switch controller of claim 9, wherein said switch controller performs said congestion control based on said examining results to determine whether a request to establish another link in said corresponding queue for a subsequently received packet is granted.

11. The switch controller of claim 10, wherein said queue control device rejects said request if the length of said corresponding queue exceeds said threshold of queue congestion; said queue control device compares the length of said corresponding queue with a predetermined threshold of escaping queue congestion which is smaller than said threshold of queue congestion; and said queue control device grants said request if the length of said corresponding queue is shorter than said threshold of escaping queue congestion.

12. The switch controller of claim 9, wherein the switch controller performs said congestion control for subsequently received packets of said ports if said remaining space of said buffer is less than a predetermined threshold of serious system congestion.

13. The switch controller of claim 12, wherein said switch controller examines whether said remaining space of said buffer is returned to a predetermined threshold of escaping serious system congestion, if said remaining space of said buffer is substantially equal to said threshold of escaping serious system congestion, then when a length of a first one of said queues is less than said threshold of queue congestion, a request to establish a link in said first queue for a subsequently received packet is granted.

14. The switch controller of claim 13, wherein when said remaining space of said buffer increases to a predetermined threshold of escaping system congestion, said switch controller stops said congestion control for said ports.

15. The switch controller of claim 14, wherein said threshold of system congestion, said threshold of serious system congestion, said threshold of escaping system congestion, said threshold of escaping serious system congestion, said threshold of queue congestion and said threshold of escaping queue congestion are stored in a register.

16. The switch controller of claim 13, wherein said threshold of escaping serious system congestion is substantially equal to said threshold of system congestion.

17. A method of congestion control, which is used in an Ethernet switch, said switch comprising a buffer, a plurality of PHY devices and a plurality of ports, said switch receiving a plurality of packets via said plurality of ports and said buffer temporarily storing said plurality of packets, said method of congestion control comprising:
performing a shared memory architecture for said buffer when said switch enters a normal state (XON);
performing an equal memory partition structure for said buffer when said switch enters a state of system congestion (XOFF); and
performing congestion control for all said plurality of ports when said switch enters a state of serious system congestion (ALL XOFF).

18. The method of congestion control of claim 17, wherein said switch further comprises a plurality of queues corresponding to said plurality of ports, a link is established for each packet in a corresponding one of said queues; when remaining space of said buffer is less than a predetermined threshold of system congestion, said switch enters said state of system congestion.

19. The method of congestion control of claim 18, wherein when said switch is in said state of system congestion, if a length of a first one of said queues exceeds a predetermined threshold of queue congestion, then one of said plurality of ports corresponding to said first queue enters a state of local congestion, said congestion control is performed for said one of said plurality of ports.

20. The method of congestion control of claim 19, wherein said switch is in said state of system congestion, if said length of said first queue is less than a predetermined threshold of escaping queue congestion, then said first queue escapes said state of local congestion.
